(19) United States
(12) Patent Application Publication
(10) Pub. No.: US 2015/0372846 A1
(43) Pub. Date: Dec. 24, 2015

(54) DUAL BAND ANALOG FRONT END FOR HIGH SPEED DATA TRANSMISSIONS IN DMT SYSTEMS

(71) Applicant: IKANOS COMMUNICATIONS, INC., Fremont, CA (US)

(72) Inventors: Debajyoti PAL, Saratoga, CA (US); Echere IROAGA, Mountain View, CA (US); William Edward KEASLER, JR., Tinton Falls, NJ (US)

(21) Appl. No.: 14/745,982

(22) Filed: Jun. 22, 2015

Related U.S. Application Data
(60) Provisional application No. 62/015,149, filed on Jun. 20, 2014.

(51) Int. Cl. H04L 27/00; H04L 5/14; H04J 3/16

(52) U.S. Cl. CPC H04L 27/0002; H04J 3/1694; H04L 5/143

(57) ABSTRACT

According to general aspects, embodiments of the invention provide an analog front end (AFE) capable of combining two independent 106 MHz G.fast baseband transmission channels into a single 212 MHz wide G.fast transmission channel. In these and other embodiments, an AFE according to the invention is also capable of interfacing to a single 212 MHz G.fast transmission channels as well as a single 106 MHz G.fast transmission channel.

### CROSS-REFERENCE TO RELATED APPLICATIONS

The present application claims priority to U.S. Prov. Appln. No. 62/015,149 filed Jun. 20, 2014, the contents of which are incorporated by reference herein in their entirety.

### FIELD OF THE INVENTION

The present invention relates to data communications, and more particularly to a dual band analog front end for high speed data transmissions.

### BACKGROUND OF THE INVENTION

ITU-T G.9701, commonly referred to as G.fast or the G.fast standard, defines a transceiver specification based on time division duplexing (TDD) for the transmission of the downstream and upstream signals in a bandwidth of approximately 106 MHz. The descriptions herein will refer to this system employing 106 MHz of bandwidth as the “first generation G.fast” system. In G.9701, a second profile for a 212 MHz bandwidth is currently planned for further study.

A first generation G.fast transceiver will use 106 MHz of channel bandwidth consisting of 2048 discrete multitone (DMT) tones (see profile 106a of the G.fast standard) and a 48 kHz symbol rate. In its second generation, a G.fast transceiver with 212 MHz of channel bandwidth is currently being planned. This system will use 4096 DMT tones and a 48 kHz symbol rate. According to the G.fast standard, the maximum bit loading can be as high as 12 bits/tone. In order to support this requirement, an analog to digital converter (ADC) with high resolution running at a very high sampling rate is needed.

A high resolution analog to digital converter (ADC) operating at a high sampling rate can consume a lot of power. Doubling the sampling rate from 212 MHz to 424 MHz can increase power consumption by far more than a factor of two if the effective number of bits (ENOB) coming out of the ADC needs to remain the same. Furthermore, the analog front end (AFE) is typically required to be backward compatible with no impact on power dissipation.

There is therefore a need for an AFE design that overcomes these obstacles, among others.

### SUMMARY OF THE INVENTION

According to general aspects, embodiments of the invention provide an analog front end (AFE) capable of combining two independent 106 MHz G.fast baseband transmission channels into a single 212 MHz wide G.fast transmission channel. In these and other embodiments, an AFE according to the invention is also capable of interfacing to a single 212 MHz G.fast transmission channels as well as a single 106 MHz G.fast transmission channel.

In accordance with these and other aspects, an apparatus in a discrete multitone (DMT) communication system having a wide band of tones comprised of non-overlapping first and second sub-bands of tones according to embodiments of the invention includes transmit and receive pins coupled to a wire pair, a first transmit and receive channel, a second transmit and receive channel, and an analog front end (AFE) capable of selectively converting digital baseband signals from one or both of the first and second transmit and receive channels into an analog signal having a bandwidth corresponding to one or both of the first and second sub-bands and driven on the transmit pin.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram of an example system implementing the sub-band approach of embodiments of the invention;

FIG. 2 is a diagram illustrating an example sub-band plan according to embodiments of the invention; and

FIG. 3 is a block diagram of an example DPU for implementing a sub-band approach toward realizing a second generation G.fast communication services according to embodiments of the invention;

FIG. 4 is a block diagram of an example embodiment of a dual band AFE according to the invention; and

FIG. 5 is a block diagram of another example embodiment of a dual band AFE according to the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

According to certain general aspects, embodiments of the invention provide an Analog Front End (AFE) for the second and higher generations of G.fast that addresses the problems described above, among other things.

In embodiments of the invention, a channel with large bandwidth is broken down into two or more non-overlapping sub bands, for example a lower sub band and an upper sub band. Each of these sub bands can be mapped to an independent base band channels via appropriate up/down conversion. Each of these base band channels can be then processed via separate circuits with ADCs operating at lower sampling rates.

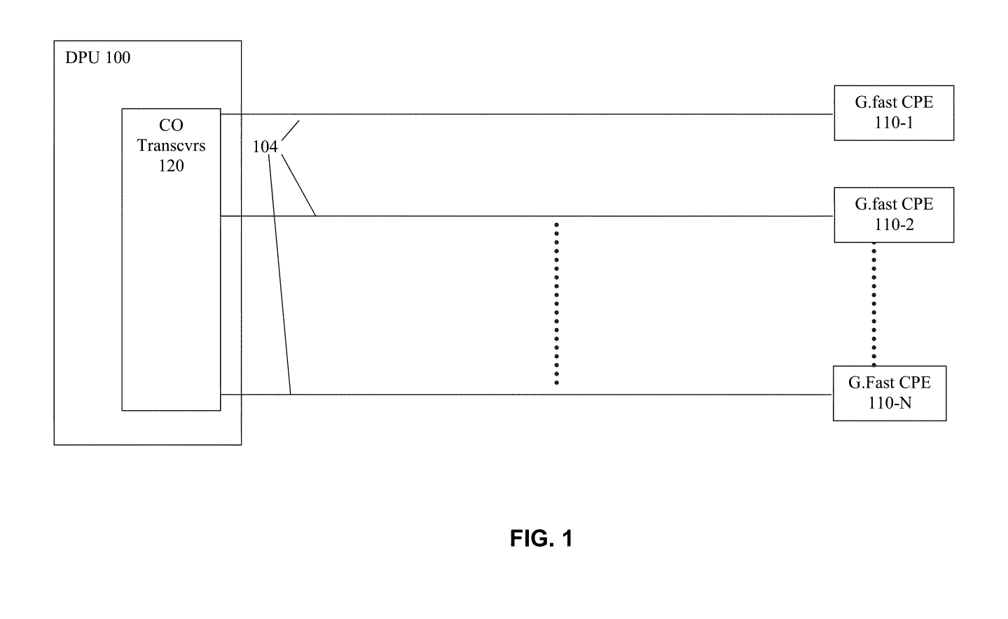

FIG. 1 is a block diagram illustrating an example system for implementing embodiments of the invention. As shown, wire pairs 104 are coupled between N G.fast CPE transceivers 110 (e.g. transceivers at customer premises such as homes) and corresponding G.fast CO transceivers 120 in DPU 100. It should be noted that transceivers 110 and 120 can communicate using time domain duplexing (TDD) as defined in the G.fast standard. However, embodiments of the invention can also include frequency domain duplexing (FDD) schemes such as those described in co-pending U.S. application Ser. No. 14/662,358, the contents of which are incorporated by reference herein in their entirety.

According to one aspect, embodiments of the invention implement a general approach of taking two independent first generation G.fast transceivers that use 2048 tones (106 MHz bandwidth) and combining them in a certain way to create a second generation G.fast transceiver that uses 4096 tones (212 MHz Bandwidth). The G.fast transceivers according to the invention can be included in CO transceivers 120, CPE transceivers 110 or both of CO transceivers 120 and CPE transceivers 110.

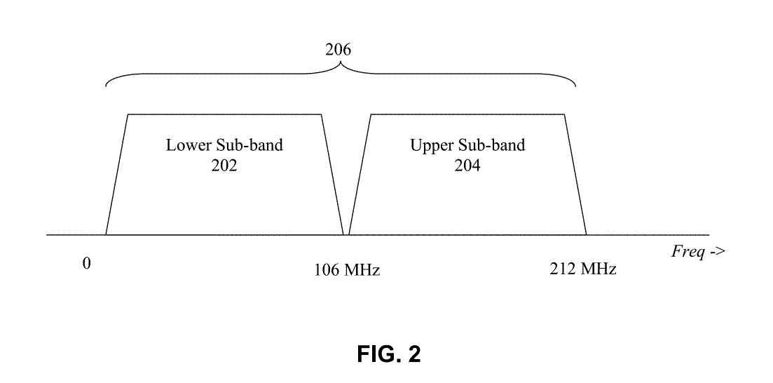

More particularly, the present inventors further recognize that a channel with 212 MHz bandwidth can be broken down into two non-overlapping 106 MHz sub bands. For example, as shown in FIG. 2, a 212 MHz bandwidth channel can be divided into a lower sub band 202 between 0 to 106 MHz and an upper sub band 204 between 106 MHz and 212 MHz, each comprising up to 2048 tones. Each of these sub bands can be mapped to an independent 106 MHz base band channel via appropriate up/down conversion. A first generation G.fast transceiver can send and receive data over either of these single 106 MHz base band channels, with data rates of up to 1 Gbps or more.

According to embodiments of the invention, furthermore, the present inventors recognize that two first generation G.fast transceivers can be used in combination to transmit and receive data over a bonded channel 206 using up to the 4096 tones in both of sub-bands 202 and 204, thus providing an aggregate rate well over 1 Gbps. In fact, over very short loops the aggregate data rate could approach 2 Gbps.

It should be noted that the principles of the invention can be extended to future generations of G.fast (e.g. up to 318 MHz) or other high bandwidth systems. In an example generation of G.fast operating with bandwidths up to 318 MHz, alternative embodiments of the invention can use three 106 MHz sub-bands and three first generation G.fast transceivers.

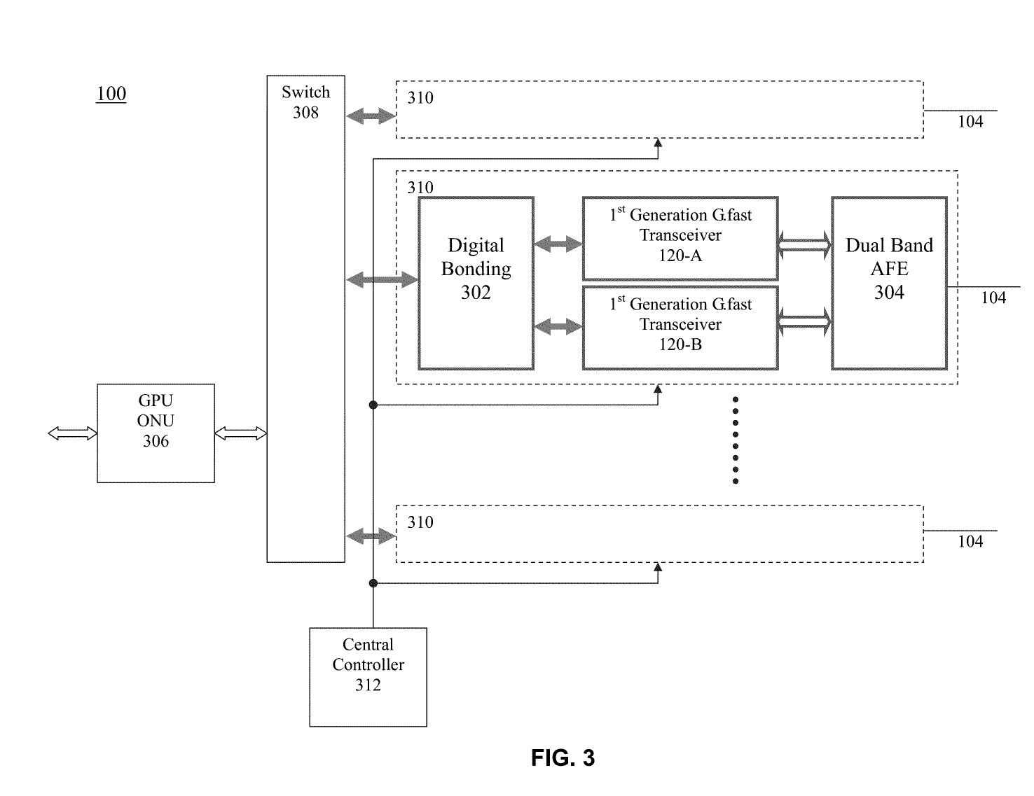

A block diagram illustrating an example DPU 100 for implementing aspects of the present invention is shown in FIG. 3. As shown, DPU 100 includes a fiber optic transceiver (GPON ONU) 306, a switch 308, a central controller 312 and a plurality of configurable channels 310 each coupled to a single line 104.

As further shown in the example of FIG. 3, each channel 310 includes a digital bonding block 302, a pair of first generation G.fast transceivers 120-A and 120-B, and a dual band analog front end (AFE) 304. Each of these components can be configured for different operational modes in accordance with signals from central controller 312, as will become more apparent from the descriptions below. It should be noted that DPU 100 may include additional components not shown in FIG. 3, such as components for performing vectoring. However, additional details regarding such additional components will be omitted here for sake of clarity of the invention.

It should be noted that a dual band AFE according to embodiments of the invention is not limited to being included in a DPU having the additional components of channels 310 such as that shown in the example implementation of FIG. 3. For example, according to aspects to be described in more detail below, embodiments of a dual band AFE according to the invention can also be included in channels having only a single first generation G.fast transceiver, or a single second generation G.fast transceiver.

In general operation of the example implementation shown in FIG. 3, during downstream TDD frames, transceivers 120 map user data received from GPON ONU 306 and switch 308 to frequency domain symbols which are converted to time domain digital outputs by transceivers 120 and then to analog signals by AFE 304. As will be described in more detail below, central controller 312 configures channels 310 for operating in one of several different modes to implement either first or second generation G.fast communications on associated line 104. In one possible example, central controller 312 can perform such configuration after or during an initial handshaking session between a transceiver 120 and a corresponding transceiver 110 coupled to line 104, when the capabilities of transceiver 110 are determined.

Additional operational and implementation aspects of central controller 312, G.fast transceivers 120 and digital bonding module 302 are described in co-pending U.S. application Ser. No. ______ (14IK11), which is incorporated by reference herein in its entirety.

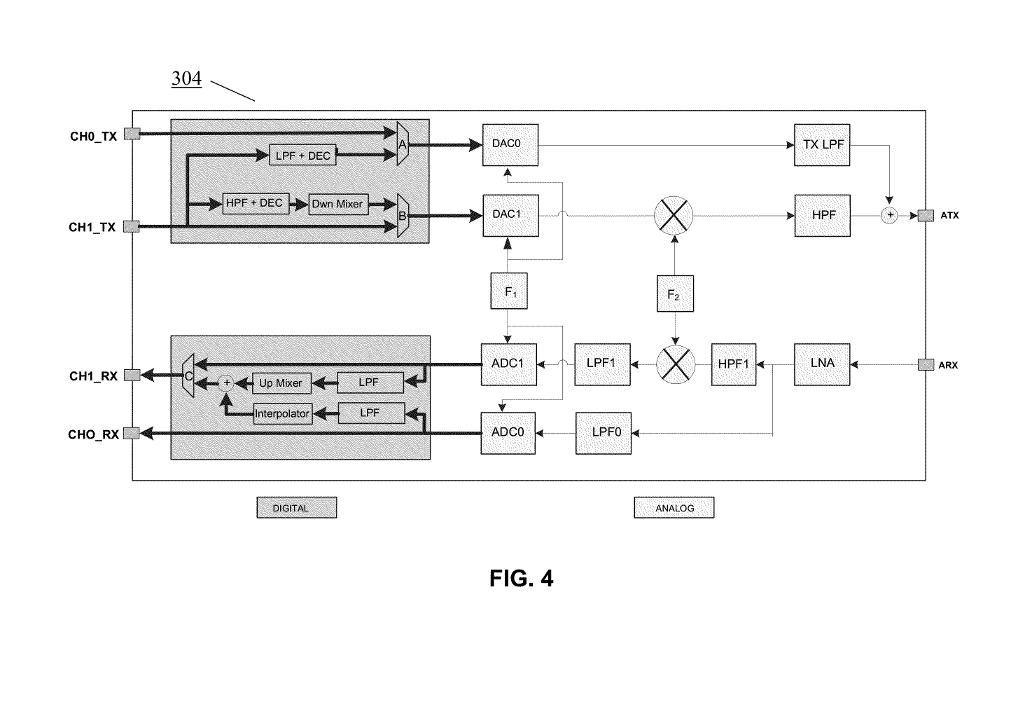

One example implementation of AFE 304 according to embodiments of the invention is illustrated in FIG. 4.

Referring to FIG. 4, this example implementation takes two digital channels with CH0_RX/TX being a 106 MHz G.fast channel and CH1_RX/TX being either a 106 MHz or a 212 MHz G.fast channel. In one example implementation, the AFE can interface with the outputs of two 106 MHz G.fast transceivers such as transceivers 120-A and 120-B shown in FIG. 3, combining them into a 212 MHz bandwidth analog signal on the line 104. In other example implementations it can also interface with one 106 Mhz G.fast transceiver or one 212 MHz G.fast transceiver effectively producing an analog signal having the corresponding bandwidth on the line 104.

For example, in the event the AFE 304 is to be used to interface with a single 106 MHz G.fast transceiver 120, the transceiver input/output will be connected to CH0_RX/TX. The digital mux A is switched by central controller 312 to select the channel CH0_TX. The transmit digital signal from the CH0_TX is converted to analog by DAC0 operating at a 212 MHz rate according to F1, filtered by the TX LPF and coupled to through ATX to line 104. The path through the HPF is disabled by central controller 312 in this case. The signal on the line 104 has a maximum bandwidth of 106 MHz in sub-band 202 matching the digital input at CH0_TX. In the receive direction, the analog signal from the line 104 on ARX is amplified by the LNA, filtered by the LPF0 and converted to digital by ADC0 operating at the 212 MHz rate according to F1. Once again, the digital signal at CH0_RX has the same maximum bandwidth (106 MHz) as the analog signal on ARX.

In the event the AFE 304 is to be used to interface with two 106 MHz G.fast DSP transceivers 120 which are to be merged into one 212 MHz analog signal on the line 104 (e.g. a bonded signal such as that described in more detail in co-pending application Ser. No. ______ (14IK11)), the inputs/outputs of the two transceivers are connected to CH0_RX/TX and CH1_RX/TX. Mux A is switched by central controller 312 to select CH0_TX, mux B is configured by central controller 312 to select CH1_TX and mux C is configured by central controller 312 to select the output of ADC1. The digital transmit signal on CH0_TX is coupled to the line 104 through DAC0 operating at a 212 MHz rate according to F1 and TX LPF. It will occupy a bandwidth from 0-106 MZz corresponding to sub-band 202. The second channel CH1_TX, is converted to digital by DAC1 operating at a 212 MHz rate according to F1, frequency translated by a mixer operating at a 106 MHz according to F2 and filter by the HPF such that the signal bandwidth sits from 106 MHz to 212 MHz corresponding to sub-band 204. These are combined and coupled to the line 104 through pin ATX. The resulting signal will have a combined bandwidth 206 from 0 to 212 MHz. In the receive direction, the 212 MHz bandwidth signal on line 104 from the ARX pin is amplified by the LNA, it is split into high frequency and low frequency pieces by the LPF0 and HPF1. The high frequency piece is mixed down to baseband using a mixer operating at a 106 MHz rate according to F2, and filtered by LPF1. Both ADC1 and ADC0 operating at a 212 MHz rate according to F1 convert the analog signals which both occupy 0 to 106 MHz bandwidths. These digital signals are sent on CH1_RX and CH0_RX to the two first generation G.fast transceivers.

In the event the AFE 304 is to be used to interface with one 212 MHz G.fast transceiver 120 (in a different embodiment of channel 310), the transceiver input/output is connected to CH1_RX/TX. Mux A is configured by central controller 312 to select the output of the “LPF+DEC” block, mux B is configured by central controller 312 to select the output of the “Dwn Mixer” block and mux C is configured by central controller 312 to select the output of the “+” block. The CH1_TX digital transmit signal is digitally split into its upper and lower bands 202 and 204 by the LPF+DEC and HPF+DEC blocks. The high frequency section is frequency translated to lower frequency by the Dwn Mixer. The two 106 MHz bandwidth signals are then converted by DAC0 and DAC1 operating at 212 MHz according to F1 to analog. The output of DAC1, which represents the high frequency piece, is translated to the higher frequency and combined with the lower frequency piece and sent to the line 104 through ATX. In the receive direction, the 212 Mhz signal from the line 104 is split into high and low frequency pieces in the analog domain as described earlier. In the digital domain, the signals are re-combined maintaining the spectral content and sent as one 212 Mhz band signal on CH1_RX.

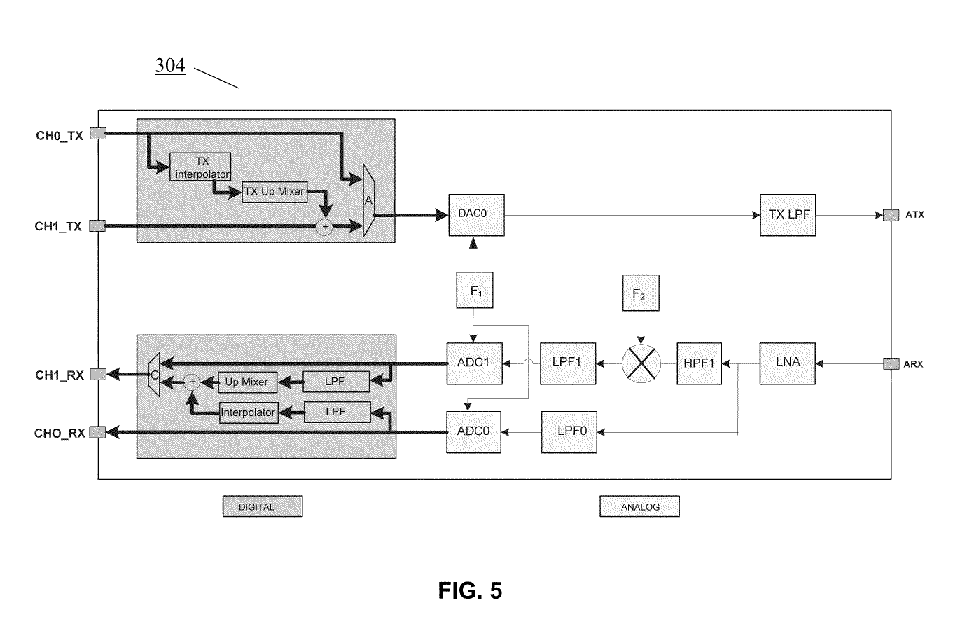

It should be noted that while FIG. 4 and the description above shows two DACs in the transmit path, It is possible and likely that only one DAC running at twice the frequency is used since the DAC power consumption is not usually an issue. In this case, the implementation would be as is shown in FIG. 5.

Embodiments of the invention achieve lower power dissipation in the ADC since they run at lower frequencies and do not require calibration for path mismatch which would be the case for time interleaved converters.

Moreover, each ADC's dynamic range is more efficiently utilized by the Automatic Gain Control (AGC) as the ADCs only see “in-band” signals. The implementation also supports backward compatibility with 106 MHz G.fast standard while supporting 212 MHz G.fast standard. And finally, the implementation can be used for “bonding” two G.fast 106 MHz channels to increase data rate.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. An apparatus in a discrete multitone (DMT) communication system having a wide band of tones comprised of non-overlapping first and second sub-bands of tones, the apparatus comprising:
transmit and receive pins coupled to a wire pair;
a first transmit and receive channel;
a second transmit and receive channel; and
an analog front end (AFE) capable of selectively converting digital baseband signals from one or both of the first and second transmit and receive channels into an analog signal having a bandwidth corresponding to one or both of the first and second sub-bands and driven on the transmit pin.

2. An apparatus according to claim 1, wherein the AFE is further capable of selectively converting an analog signal using one or both of the first and second sub-bands from the receive pin into digital baseband signals provided to one or both of the first and second transmit and receive channels.

3. An apparatus according to claim 1, wherein the AFE includes:
a first multiplexer for selectively passing one of the digital baseband signals from the first transmit and receive channel;
a first digital to analog converter for converting the one digital baseband signal to a first portion of the analog signal corresponding to the first sub-band;
a second multiplexer for selectively passing another of the digital baseband signals from the second transmit and receive channel;
a second digital to analog converter for converting the one digital baseband signal to a second portion of the analog signal; and
a mixer for causing the second portion to occupy the second sub-band.

4. An apparatus according to claim 1, wherein the AFE includes:
a low pass filter for passing a first portion of a digital baseband signal from the second transmit and receive channel;
a first multiplexer for selectively passing the first portion of the digital baseband signal;
a first digital to analog converter for converting the first portion of the digital baseband signal to a first portion of the analog signal corresponding to the first sub-band;
a high pass filter for passing a second portion of the digital baseband signal from the second transmit and receive channel;
a down mixer for converting the second portion of the digital baseband signal to baseband;
a second multiplexer for selectively passing the converted second portion of the digital baseband signal;
a second digital to analog converter for converting the converted second portion of the digital baseband signal to a second portion of the analog signal; and
a mixer for causing the second portion to occupy the second sub-band.

5. An apparatus according to claim 2, wherein the AFE includes:
a lowpass filter for passing a first portion of the analog signal corresponding to the first sub-band;
a first analog to digital converter for converting the first portion of the analog signal to one digital baseband signal;
a first multiplexer for selectively passing the one digital baseband signal to the first transmit and receive channel;
a highpass filter for passing a second portion of the analog signal corresponding to the second sub-band;
a mixer for converting the second portion to baseband;
a second analog to digital converter for converting the second portion of the analog signal to another digital baseband signal;
a second multiplexer for selectively passing the another digital baseband signal to the second transmit and receive channel.

6. An apparatus according to claim 1, wherein the digital baseband signals comprise a single 106 MHz G.fast digital baseband signal and the analog signal has a bandwidth corresponding to the first sub-band.

7. An apparatus according to claim 1, wherein the digital baseband signals comprise two 106 MHz G.fast digital baseband signals and the analog signal has a bandwidth corresponding to the first and second sub-bands.

8. An apparatus according to claim 1, wherein the digital baseband signals comprise a single 212 MHz G.fast digital baseband signal and the analog signal has a bandwidth corresponding to the first and second sub-bands.

9. An apparatus according to claim 2, wherein the analog signal has a bandwidth corresponding to the first sub-band and the digital baseband signals comprise a single 106 MHz G.fast digital baseband signal.

10. An apparatus according to claim 2, wherein the analog signal has a bandwidth corresponding to the first and second sub-bands and the digital baseband signals comprise two 106 MHz G.fast digital baseband signals.

11. A method for performing discrete multitone (DMT) communications, the method comprising:
partitioning a wide bandwidth into at least first and second non-overlapping sub-bands;
selectively receiving one or both of first and second digital baseband signals; and
selectively converting one or both of the digital baseband signals into an analog signal having a bandwidth corresponding to one or both of the first and second sub-bands.

12. A method according to claim 11, wherein both the first and second digital baseband signals use tones in one of the first and second non-overlapping sub-bands.

13. A method according to claim 11, wherein selectively converting includes:
selecting to receive both of the first and second digital baseband signals;
creating a first portion of the analog signal using the first digital baseband signal;
causing the first portion to use the first sub-band;
creating a second portion of the analog signal using the second digital baseband signal; and
causing the second portion to use the second sub-band.

14. A method according to claim 11, further comprising:
receiving an analog signal having the wide bandwidth;
converting the analog signal into third and fourth digital baseband signals.

15. A method according to claim 11, further comprising:
selecting to receive only the first digital baseband signal; and
converting the first baseband signal into another single analog signal, the another single analog signal having a bandwidth of one of the first and second sub-bands.

16. A method according to claim 11, further comprising:
selecting to receive only the first digital baseband signal; and
converting the first baseband signal into another single analog signal, the another single analog signal having a bandwidth of both of the first and second sub-bands.

17. A method according to claim 11, further comprising:
receiving an analog signal having the bandwidth of one of the first and second sub-bands;
converting the analog signal into a third digital baseband signal.

18. A method according to claim 11, wherein the first and second digital baseband signals are produced by G.fast transceivers, each operating up to 106 MHz.
